(19) United States
(12) Patent Application Publication
(10) Pub. No.: US 2010/0312749 A1
(43) Pub. Date: Dec. 9, 2010

(54) SCALABLE LOOKUP SERVICE FOR DISTRIBUTED DATABASE

(75) Inventors: Murali Brahmadesam, Woodinville, WA (US); Yan Valerie Leshinsky, Kirkland, WA (US); Elissa E.S. Murphy, Seattle, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/478,039

(22) Filed: Jun. 4, 2009

(51) Int. Cl. G06F 17/30; G06F 12/00; G06F 12/02

(52) U.S. Cl. 707/609; 711/E12.001; 711/E12.002; 707/770; 707/812

(57) ABSTRACT

An embodiment of the invention is directed toward locating a file chunk in a distributed database. A hash partition containing a hash of a location of the file chunk is determined. A node hosting the hash partition is determined. A list of database partitions containing the file chunk is requested from the node. A list of database partitions is received.

With the large-scale adoption of cloud storage, the capacity to store data increases at a rapid rate. Files can be divided into small portions, called file chunks, and distributed across nodes. In such a system it could be necessary to locate a large number of file chunks to access a complete file. These file chunks could be distributed over a number of different nodes. Locating such chunks without contacting a large number of storage nodes can increase the efficiency of such a system. A single node may not have the storage capacity to keep an index of the location of every file chunk stored in the system.

### SUMMARY

This Summary is generally provided to introduce the reader to one or more select concepts described below in the Detailed Description in a simplified form. This Summary is not intended to identify the invention or even key features, which is the purview of claims below, but is provided to be patent-related regulation requirements.

One embodiment of the invention includes locating a file chunk in a distributed database. A hash partition containing a hash of a content of the file chunk is determined. A node hosting the hash partition is determined. A list of database partitions containing the file chunk is requested from the node. A list of database partitions is received.

Another embodiment includes locating a file chunk in a distributed database. A request for a list of database partitions containing the file chunk is received. A number of filters is applied to a hash related to the file chunk. Each of the filters is related to a particular database partition. A list of database partitions containing the file chunk is determined based on the application of the filters. A message is sent that replies to the request. The message contains the list of database partitions containing the file chunk.

### BRIEF DESCRIPTION OF THE DRAWING

Illustrative embodiments of the present invention are described in detail below with reference to the attached drawing figures, and wherein:

FIG. 1 is block diagram of an exemplary computing device suitable for practicing embodiments of the inventions;

FIG. 2 is a block diagram of a network made up of multiple sectors suitable for practicing embodiments of the invention;

FIG. 3 is a block diagram depicting a hash space, in accordance with embodiments of the invention;

FIG. 4 is a block diagram depicting a distributed database, in accordance with embodiments of the invention;

FIG. 5 is a flow diagram depicting a method of locating a file chunk in a distributed database by determining a hash partition, in accordance with embodiments of the invention;

FIG. 6 is a flow diagram depicting a method of locating a file chunk in a distributed database, in accordance with embodiments of the invention; and

FIG. 7 is a flow diagram depicting a method of locating a file chunk in a distributed database utilizing a bloom filter, in accordance with embodiments of the invention.

### DETAILED DESCRIPTION

The subject matter of the present invention is described with specificity to meet statutory requirements. However, the description itself is not intended to define the scope of the claims. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

Embodiments of the invention are directed toward locating a portion of a file in a distributed database. Distributed database systems allow files or portions of files, called file chunks, to be stored across many different nodes in a network of nodes. Nodes could be any computing device capable of providing network connectivity and some storage capacity. Locating a file chunk can be performed by a lookup service. The lookup service could provide the node and database partition where the file chunk could be retrieved.

The location of a file chunk could be determined in part by the value of a hash function applied to some characteristics of the file chunk. A hash function, in accordance with embodiments of the invention, could be any well-defined function that maps a large amount of data into a smaller amount of data, or a hash value. The hash value could be used as an index to locate the information. For example, the name, size, and portion of the file for a file chunk could be used in calculating the value of a hash function. This value could map to a location or a set of locations where the file chunk could be stored. According to an embodiment of the invention, the hash space (i.e., the possible values of the hash function) could be divided into a number of partitions. These hash partitions could then be distributed across a number of nodes. Additionally, each hash partition could be stored on more than one node. By way of example, each partition could be stored on at least two nodes. Storing each partition on multiple nodes could increase fault tolerance and decrease lookup time. For example, a node could be chosen to host a hash based on load information. Load balancing could be performed by distributing hash partitions among the various nodes in the system. By partitioning the hash space, a lookup can go to a single node. For example, the lookup service can find the hash value associated with the desired file chunk and then request a lookup from the node responsible for that particular hash partition.

One or more databases used for storing file chunks, according to an embodiment of the invention, could be divided into partitions. Each database partition would act as a logically independent database. Database partitions could be replicated on a number of nodes. Such replication could increase fault tolerance and decrease lookup times. A file chunk could be stored in one or more database partitions. According to some embodiments of the invention, each hash partition will contain a number of database partitions. A file chunk with a hash value related to the hash partition could be stored in one or more database partitions contained in the hash partition.

To locate a file chunk, a hash value associated with the file chunk could be calculated. The hash partition containing the hash value could be determined and a node responsible for that hash partition could be located. A lookup request could be sent to that node. The node could then determine if the requested file chunk exists in any of the database partitions within the hash partition. According to an embodiment of the invention, a filter could be applied to the hash value associated with the file chunk for each database partition to determine which database partitions could contain the file chunk.

According to some embodiments of the invention, a Bloom filter could be used to determine if a particular file chunk is in each database partition. A Bloom filter could be created for each database partition. The Bloom filters could be periodically created to capture file chunk removal. Additionally, the Bloom filters could be created as background processes. According to an embodiment of the invention, a Bloom filter could be defined by a number of hash functions. Each hash function could be applied to a particular file chunk. Locations in the filter identified by the corresponding hash values could be set to 1. A file chunk could then be determined to be in a database partition if all of the locations in the corresponding Bloom filter that are identified by the hash values related to the file chunk are set to 1. According to some embodiments, the database partitions that are identified as having the file chunk by the Bloom filters could be searched to verify that the file chunk is present. There could be a probability that a Bloom filter associated with a database partition indicates that a file chunk is contained in the database partition but that the file chunk is not actually in the database partition (i.e., a false positive). According to some embodiments of the invention, the Bloom filters could be created to give a particular bound on the probability that a false positive will occur. According to some embodiments of the invention, the Bloom filters for each of the database partitions associated with a particular hash partition could be applied to a particular file chunk at the same time (i.e., in parallel). Additionally, each Bloom filter could be stored on a number of nodes.

An embodiment of the invention is directed to locating a file chunk in a distributed database. A hash partition containing a hash of the content of the file chunk is determined. A node hosting the hash partition is determined. A list of database partitions containing the file chunk is requested from the node. A list of database partitions is received.

Another embodiment is directed to locating a file chunk in a distributed database. A request for a list of database partitions containing the file chunk is received. A number of filters is applied to a hash related to the file chunk. Each of the filters is related to a particular database partition. A list of database partitions containing the file chunk is determined based on the application of the filters. A message is sent that replies to the request. The message contains the list of database partitions containing the file chunk.

A further embodiment is directed to locating a file chunk in a distributed database. A request for a list of database partitions containing the file chunk is received. The request includes a hash related to the file chunk. Each of a number of Bloom filters is applied to the hash. The Bloom filters are associated with particular database partitions. Based on the application of the Bloom filters, a list of database partitions containing the file chunk with a certain probability is determined. The request is replied to with a message containing the list of database partitions.

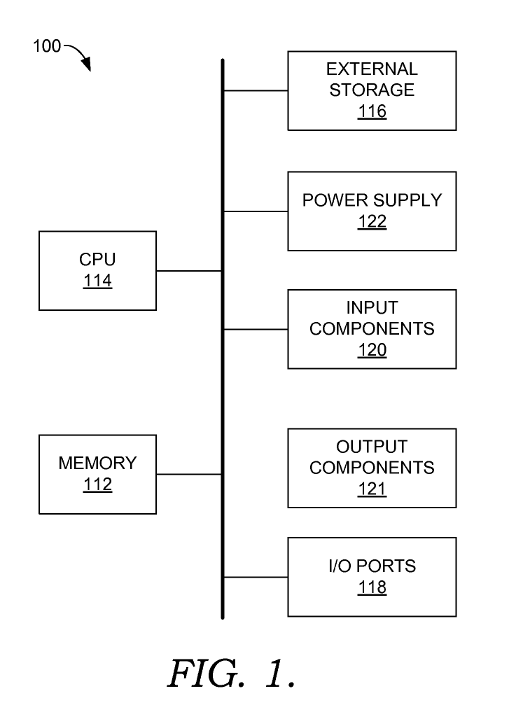

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more external storage components 116, input/output (I/O) ports 118, input components 120, output components 121, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, many processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile memory. Exemplary hardware devices include solid-state memory, such as RAM. External storage 116 includes computer-storage media in the form of non-volatile memory. The memory may be removable, nonremovable, or a combination thereof. Exemplary hardware devices include solid-state memory, hard drives, optical-disc drives, etc. Computing device 100 includes one or more processors that read data from various entities such as memory 112, external storage 116 or input components 120. Output components 121 present data indications to a user or other device. Exemplary output components include a display device, speaker, printing component, vibrating component, etc.

I/O ports 118 allow computing device 100 to be logically coupled to other devices including input components 120 and output components 121, some of which may be built in. Illustrative components include a microphone, joystick, game pad, satellite dish, scanner, printer, wireless device, etc.

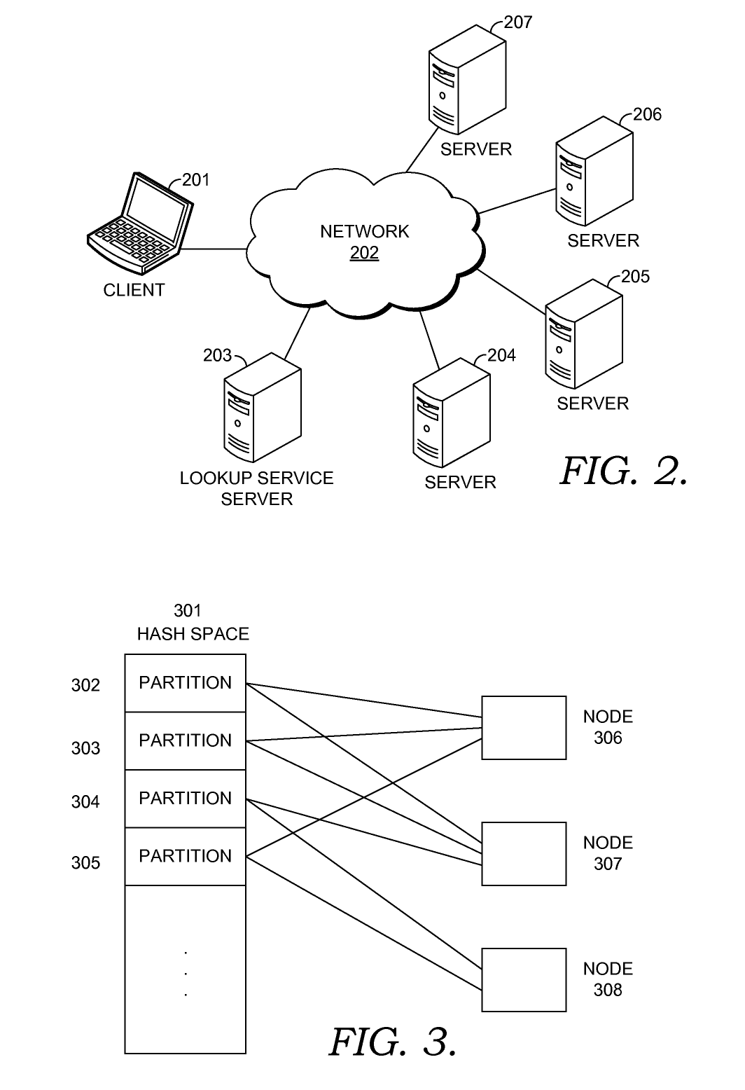

Turning to FIG. 2, a block diagram depicting a network environment suitable for use with embodiments of the invention is given. A client computing device 201 is connected to a network 202. There are a number of suitable devices that could be the client 201. By way of example, laptops, desktop computers, mobile phones, and personal digital assistants could be client devices 201. The network 202 could be an intranet, such as a corporate intranet. The network 202 could also be a wide-area network such as the Internet. A number of servers 203, 204, 205, 206, 207 are connected to the network 202. Each of the servers 203-207 could be suitable to be responsible for one or more hash partitions. Each of the hash partitions could contain one or more database partitions. According to an embodiment, one of the servers 203 could serve as a lookup service server. This server 203 could identify which of the other servers 204-207 are responsible for particular hash partitions. A client 201 looking for a particular file chunk could first contact the lookup service server 203 via the network 202 to determine which of the other servers 204-207 is responsible for the hash partition related to the desired file chunk.

Turning now to FIG. 3, a block diagram depicting a hash space 301 is given. The hash space 301 contains all possible values of a particular hash function. The hash space 301 can be divided into a number of partitions 302, 303, 304, 305. Each partition 302-305 can be associated with one or more nodes 306, 307, 308. Each node (e.g., 307) could be responsible for any file chunks that hash to a hash value in the partition associated with them (e.g., 302, 303, 304). Hash partitions 302-305 could be associated with nodes 306-308 based on a number of criteria. For example, a threshold number of replications of hash partitions 302-305 could be created. As another example, the average load on each node 306-308 could be considered in determining where to place hash partitions 302-305.

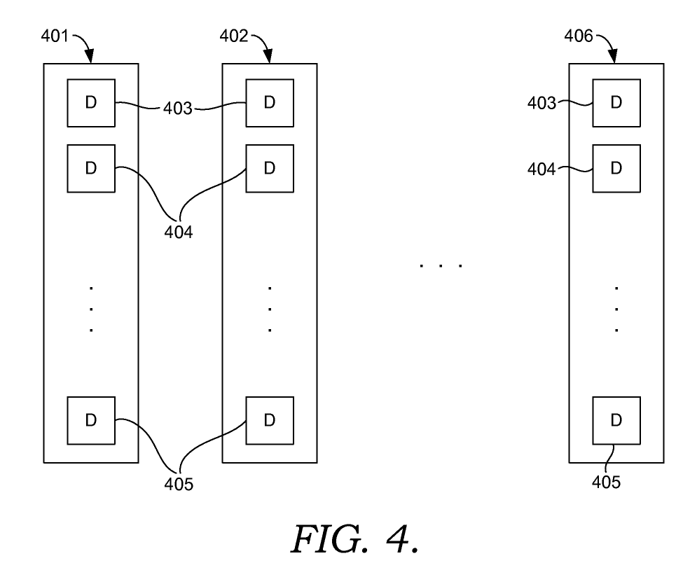

Turning now to FIG. 4, a block diagram depicting a number of hash partitions 401, 402, 406 is given. Each hash partition could contain a number of database partitions 403, 404, 405. Database partitions 403, 404, 405 could be replicated among a number of nodes in addition to the hash partitions 401, 402, 406 being replicated. Each database partition 403, 404, 405 could have a filter associated with it. The filter could be used to determine if a particular file chunk is present in the associated database partition 403, 404, 405. For example, a hash function could be applied to a file chunk. The resulting hash value could determine a hash partition 401, 402, 406 to search in for the file chunk. Filters associated with each database partition 403, 404, 405 within the determined hash partition 401, 402, 406 could be applied to determine a list of one or more database partitions 403, 404, 405 containing the file chunk. According to some embodiments, there is a probability that one or more of the database partitions 403, 404, 405 in the list may not contain the file chunk. Each of the database partitions 403, 404, 405 in the list could be search for the file chunk to determine if the file chunk is in each of the database partitions 403, 404, 405 in the list.

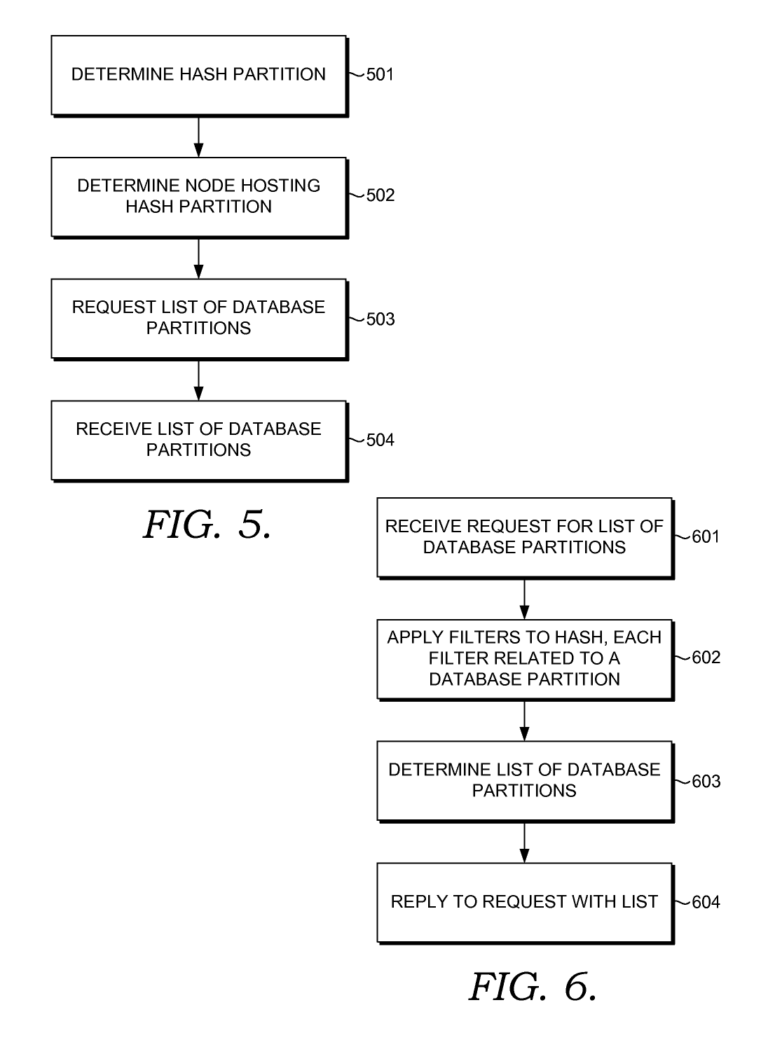

Turning now to FIG. 5, a flow diagram depicting a method of determining a list of database partitions containing a file chunk is given. A hash partition containing a hash of a location of the file chunk is determined, as shown in block 501. The hash partition could be determined by applying a hash function to a number of characteristics of the file chunk. For example, the name of the file and an identification of the segment of the file contained in the file chunk could be used as inputs to the hash function. There are other characteristics of the file that could be used to determine a hash value for use in determining a hash partition.

A node hosing the hash partition is determined, as shown at block 502. According to embodiments of the invention, a chunk hash lookup service could be used to map hash partitions to specific nodes. For example, the lookup service could store information relating hash partitions to the addresses of one or more nodes responsible for file chunks with hash values that fall within the hash partitions. According to an embodiment, the lookup service could return one of two or more nodes associated with the hash partition. For example, the lookup service could chose a node to return as the node responsible for a requested hash partition based on the load on each of the nodes associated with the hash partition.

A list of one or more database partitions containing the file chunks is requested, as shown at block 503. The list could be requested by sending a packet with identifying information related to the file chunk to the node determined to be associated with the hash partition. According to an embodiment, the list is requested by sending a packet with a hash value of characteristics associated with the file chunk to the node. As an example, the lookup service could send the request to the node. As another example, the client could directly contact the node associated with the hash partition.

A list of one or more database partitions is received, as shown at block 504. According to an embodiment of the invention, the list is determined by applying filters associated with each database partition that is associated with the hash partition. For example, the filters could be Bloom filters. Bloom filters could be used to identify a database partition as containing a file chunk with a given probability. According to some embodiments, each of the database partitions in the list could be searched to determine if the file chunk is contained in each database partition.

Turning now to FIG. 6, a flow diagram depicting a method of locating one or more database partitions containing a file chunk is given. A request for a list of one or more database partitions containing the file chunk is received, as shown at block 601. The request could include a hash value associated with the file chunk. The request could contain characteristics related to the file chunk. According to an embodiment, the request could originate from a client device. According to another embodiment, the request could originate from a lookup server.

A number of filters are applied to a hash related to the file chunk, as shown at block 602. Each of the filters is associated with a particular database partition. According to an embodiment of the invention, the filters could be Bloom filters. The Bloom filters could be used to determine that a file chunk is contained in a particular database partition with a given probability. Each of the Bloom filters could be applied at the same time (i.e., in parallel). According to some embodiments, the Bloom filters associated with each of the database partitions could be recalculated. For example, the Bloom filters could be recalculated periodically. As another example, the Bloom filters could be recalculated responsive to some transaction. An example transaction could be the removal of a file chunk from a database partition. The Bloom filter recalculation could be performed as a background process.

A list of database partitions is determined, based on the application of the filters, as shown at block 603. For example, a list containing every database partition for which the filter application indicated that the file chunk was contained within it could be returned. As another example, a list of a subset of those databases could be returned. The subset could be chosen based on a number of characteristics. For example, each database partition could be searched to verify the existence of the file chunk. A message containing the list is sent in reply to the request, as shown at block 604.

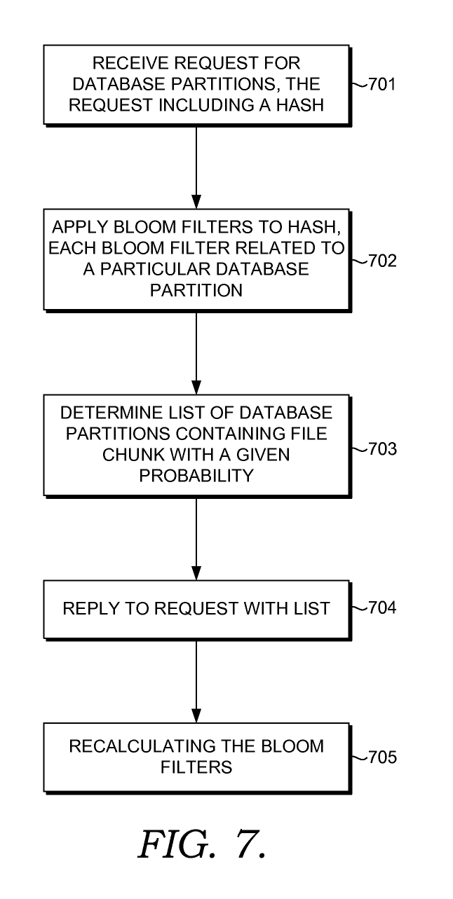

Turning now to FIG. 7, a flow diagram depicting a method of locating a file chunk in a distributed database is given. A request for a list of one or more database partitions containing a file chunk is received, as shown at block 701. The request contains a hash related to the file chunk. A number of Bloom filters are applied to the hash related to the file chunk, as shown at block 702. Each of the Bloom filters are related to a particular database partition. Each Bloom filter, when applied to the hash, can indicate that the file chunk is contained in a particular database partition with a given probability.

A list of database partitions containing the file chunk with a given probability is determined, based on the application of the Bloom filters, as shown at block 703. Probability is determined by the size of the Bloom filer. Using a Bloom filter in combination with the hash can increase the speed of accessing data with a minimal chance of missing data. A message containing the list is sent in reply to the request as shown at block 704. The Bloom filters associated with each of the database partitions is recalculated, as shown at block 705. The recalculation could occur responsive to a particular transaction. According to some embodiments of the invention, the recalculation occurs as a background process.

Alternative embodiments and implementations of the present invention will become apparent to those skilled in the art to which it pertains upon review of the specification, including the drawing figures. Accordingly, the scope of the present invention is defined by the claims that appear in the “claims” section of this document, rather than the foregoing description.

The invention claimed is:

1. One or more computer-readable media having computer-executable instructions embodied thereon that, when executed, cause a computing device to perform a method of locating a file chunk in a distributed database, the method comprising:
determining a hash partition containing a hash of a location of the file chunk;
determining a node hosting the hash partition;
requesting from the node a list of one or more database partitions containing the file chunk; and
receiving the list of one or more database partitions.

2. The media of claim 1, wherein determining a hash partition includes determining a value of a hash function for the file chunk and determining the hash partition containing the value.

3. The media of claim 2, wherein determining a node includes utilizing a chunk hash lookup service to map the hash partition containing the value to a particular node.

4. The media of claim 3, wherein the chunk hash lookup service maps the hash partition containing the value to two or more nodes.

5. The media of claim 4, wherein one of the two or more nodes is chosen as the node hosting the hash partition based on load information.

6. The media of claim 1, wherein the list of one or more database partitions is determined by applying one or more filters to a hash related to the file chunk.

7. The media of claim 6, wherein each of the one or more filters is related to a particular database partition.

8. The media of claim 7, wherein the one or more filters are Bloom filters.

9. The media of claim 1, wherein the one or more database partitions in the list contain the file chunk with a given probability.

10. The media of claim 1, further comprising searching each of the one or more database partitions for the file chunk.

11. One or more computer-readable media having computer-executable instructions embodied thereon that, when executed, cause a computing device to perform a method of locating a file chunk in a distributed database, the method comprising:
receiving a request for a list of one or more database partitions containing the file chunk;
applying each of a number of filters to a hash related to the file chunk, each of said number of filters being related to a particular database partition;
based on the application of the number of filters, determining a list of one or more database partitions containing the file chunk; and
replying to the request with a message containing the list.

12. The media of claim 11, wherein the request includes the hash related to the file chunk.

13. The media of claim 11, wherein applying each of a number of filters includes applying one or more subsets of the filters in parallel.

14. The media of claim 11, wherein the number of filters are Bloom filters.

15. The media of claim 11, wherein the one or more database partitions in the list contain the file chunk with a given probability.

16. The media of claim 11, further comprising recalculating each of the number of filters.

17. The media of claim 16, wherein the recalculating is a background process.

18. One or more computer-readable media having computer-executable instructions embodied thereon that, when executed, cause a computing device to perform a method of locating a file chunk in a distributed database, the method comprising:
receiving a request for a list of one or more database partitions containing the file chunk, the request including a hash related to the file chunk;
applying each of a number of Bloom filters to a hash related to the file chunk, each of said number of Bloom filters being related to a particular database partition;
based on the application of the number of Bloom filters, determining a list of one or more database partitions containing the file chunk with a given probability; and
replying to the request with a message containing the list.

19. The media of claim 18, wherein applying each of a number of Bloom filters includes applying one or more subsets of the Bloom filters in parallel.

20. The media of claim 18, wherein each of the one or more database partitions are located at different nodes.
